(19) United States
(12) Patent Application Publication
(10) Pub. No.: US 2026/0089508 A1
(43) Pub. Date: Mar. 26, 2026

(54) ELECTRONIC DEVICE AND METHOD OF CONTROLLING THE SAME, AND METHOD OF CONTROLLING A SYSTEM INCLUDING THE ELECTRONIC DEVICE AND AT LEAST ONE DEVICE

(71) Applicant: Samsung Electronics Co., Ltd., Suwon-si (KR)

(72) Inventors: Woojin PARK, Suwon-si (KR); Wookwon KOO, Suwon-si (KR); Daehyun KWON, Suwon-si (KR); Bhavesh DHINGRA, Suwon-si (KR); Kangin PARK, Suwon-si (KR); Jaewoo SEO, Suwon-si (KR); Changhoon LEE, Suwon-si (KR); Jungil CHO, Suwon-si (KR)

(21) Appl. No.: 19/374,539

(22) Filed: Oct. 30, 2025

Related U.S. Application Data
(63) Continuation of application No. PCT/KR2025/014861, filed on Sep. 23, 2025.

(30) Foreign Application Priority Data
Sep. 24, 2024 (KR) 10-2024-0128936

(51) Int. Cl. H04W 12/084; H04W 76/10; H04W 84/12

(52) U.S. Cl. CPC H04W 12/084; H04W 76/10; H04W 84/12

(57) ABSTRACT

An electronic device is provided. The electronic device includes a communication circuitry, memory storing at least one instruction, and at least one processor communicatively coupled to the communication circuitry and the memory, wherein the at least one instruction, when executed by the at least one processor individually or collectively, causes the electronic device to, based on being connected to an access point by using first communication setting information, record the first communication setting information in a blockchain network, and the blockchain network storing information on at least one device registered by the same user account as the electronic device; based on determining an event for connecting to the access point by second communication setting information has occurred, record the second communication setting information in the blockchain network; and based on the recording of the second communication setting information in the blockchain network succeeding, perform connection with the access point by using the second communication setting information.

### CROSS-REFERENCE TO RELATED APPLICATION(S)

This application is a continuation application, claiming priority under 35 U.S.C. § 365(c), of an International application No. PCT/KR2025/014861, filed on Sep. 23, 2025, which is based on and claims the benefit of a Korean patent application number 10-2024-0128936, filed on Sep. 24, 2024, in the Korean Intellectual Property Office, the disclosure of which is incorporated by reference herein in its entirety.

### TECHNICAL FIELD

The disclosure relates to an electronic device that can perform communicative connection by using a blockchain network and a method of controlling the same. More particularly, the disclosure relates to a method of controlling a system including an electronic device and at least one device.

### BACKGROUND ART

Recently, technologies related to the Internet of Things (IoT) are developing rapidly. In particular, various electronic devices may be connected with one another and constitute a home IoT system. Such a home IoT system is providing various services to a user.

Meanwhile, in an IoT system, a plurality of devices may perform communicative connection by using a wireless fidelity (Wi-Fi) access point. In case the connected Wi-Fi access point is not safe, the devices in the IoT system provide a guide that takes a measure such that the devices can be connected to the Wi-Fi access point by a safe method.

When such a guide is provided, a user changed the setting by directly connecting to the Wi-Fi access point. That is, the user directly inputs an Internet Protocol (IP) address and a password, and changes the encryption method, and thereby makes the devices in the IoT system connected to the Wi-Fi access point by a safe method. In case the setting of communicative connection such as the encryption method, etc. is changed, communicative connection of the other devices connected to the Wi-Fi access point is disconnected. Accordingly, there is an inconvenience for the user of having to perform communicative connection of the other devices one by one.

The above information is presented as background information only to assist with an understanding of the disclosure. No determination has been made, and no assertion is made, as to whether any of the above might be applicable as prior art with regard to the disclosure.

### DISCLOSURE OF INVENTION

### Solution to Problem

Aspects of the disclosure are to address at least the above-mentioned problems and/or disadvantages and to provide at least the advantages described below. Accordingly, an aspect of the disclosure is to provide a method of controlling a system including an electronic device and at least one device.

Additional aspects will be set forth in part in the description which follows and, in part, will be apparent from the description, or may be learned by practice of the presented embodiments.

In accordance with an aspect of the disclosure, an electronic device is provided. The electronic device includes a communication circuitry, memory storing at least one instruction, and at least one processor communicatively coupled to the communication circuitry and the memory, wherein the at least one instruction, when executed by the at least one processor individually or collectively, causes the electronic device to, based on being connected to an access point by using first communication setting information, record the first communication setting information in a blockchain network, and the blockchain network storing information on at least one device registered by the same user account as the electronic device, based on determining an event for connecting to the access point by second communication setting information has occurred, record the second communication setting information in the blockchain network, and based on the recording of the second communication setting information in the blockchain network succeeding, perform connection with the access point by using the second communication setting information.

The at least one instruction, when executed by the at least one processor individually or collectively, may further cause the electronic device to, identify security strength of a first security protocol included in the first communication setting information, based on the identifying the security strength, provide a user interface (UI) for changing a security protocol for connecting to the access point from the first security protocol to a second security protocol, the second security protocol having higher security strength than the first security protocol, and based on receiving a user input for changing the security protocol through the UI, determine that an event for connecting to the access point by the second communication setting information including the second security protocol has occurred.

The at least one instruction, when executed by the at least one processor individually or collectively, may further cause the electronic device to, based on the recording of the second communication setting information in the blockchain network succeeding, obtain the information on the at least one device recorded in the blockchain network, and based on identifying each of at least one device being in a state of connected to the blockchain network and power-on, perform connection with the access point by using the second communication setting information.

The at least one instruction, when executed by the at least one processor individually or collectively, may further cause the electronic device to, based on identifying a device in a state of disconnected to the blockchain network or power-off among the at least one device, provide a UI requesting connection to the blockchain network or power-on of the identified device, and based on the connection or the power-on of the identified device being performed, perform connection with the access point by using the second communication setting information.

The at least one instruction, when executed by the at least one processor individually or collectively, may further cause the electronic device to, based on identifying a device in a state of disconnected to the blockchain network or power-off among the at least one device, provide a UI for changing the first communication setting information after a standby time, and based on receiving a user input, perform the connection with the access point by using the second communication setting information.

The at least one instruction, when executed by the at least one processor individually or collectively, may further cause the electronic device to, based on a user input corresponding to the changing after the standby time, perform the connection with the access point by using the second communication information after elapsing the standby time, and based on a user input corresponding to the changing without the standby time, perform the connection with the access point by using the second communication information immediately, wherein the standby time comprises a time based on use pattern information of the identified device.

The at least one instruction, when executed by the at least one processor individually or collectively, may further cause the electronic device to, based on identifying a device which is disconnected to the blockchain network or power-off, and not being able to perform an operation related to the blockchain, among the at least one device, identify another device which is able to perform the operation related to the blockchain and is connected to the identified device, and request the another device to transmit a signal corresponding to a user input for controlling the identified device to the identified device.

The at least one instruction, when executed by the at least one processor individually or collectively, may further cause the electronic device to, based on an encryption set value included in the first communication setting information being set to be changed by a predetermined cycle, perform connection with the access point by using the second communication setting information before changing the encryption set value.

The blockchain network may store communication setting information of a communication interface different from the communication interface, log-in information of a service used by the user, and security information.

In accordance with another aspect of the disclosure, a method performed by an electronic device is provided. The method includes based on being connected to an access point by using first communication setting information, recording, by the electronic device, the first communication setting information in a blockchain network, and the blockchain network storing information on at least one device registered by the same user account as the electronic device, based on determining an event for connecting to the access point by second communication setting information has occurred, recording, by the electronic device, the second communication setting information in the blockchain network, and based on the recording of the second communication setting information in the blockchain network succeeding, performing, by the electronic device, connection with the access point by using the second communication setting information.

The method may include the steps of, identifying security strength of a first security protocol included in the first communication setting information, based on the identifying the security strength, providing a UI for changing a security protocol for connecting to the access point from the first security protocol to a second security protocol, the second security protocol having higher security strength than the first security protocol, and based on receiving a user input for changing the security protocol through the UI, determining that an event for connecting to the access point by the second communication setting information including the second security protocol has occurred.

The performing step may include the steps of, based on the recording of the second communication setting information in the blockchain network succeeding, obtaining the information on the at least one device recorded in the blockchain network, and based on identifying each of at least one device being in a state of connected to the blockchain network and power-on, performing connection with the access point by using the second communication setting information.

The performing step may include the steps of, based on identifying a device in a state of disconnected to the blockchain network or power-off among the at least one device, providing a UI requesting connection to the blockchain network or power-on of the identified device, and based on the connection or the power-on of the identified device being performed, performing connection with the access point by using the second communication setting information.

The performing step may include the steps of, based on identifying a device in a state of disconnected to the blockchain network or power-off among the at least one device, providing a UI for changing the first communication setting information after a standby time, and based on receiving a user input, performing the connection with the access point by using the second communication setting information.

The performing step may include the steps of, based on a user input corresponding to the changing after the standby time, performing the connection with the access point by using the second communication information after elapsing the standby time, and based on a user input corresponding to the changing without the standby time, performing the connection with the access point by using the second communication information immediately, wherein the standby time comprises a time based on use pattern information of the identified device.

The method may include the steps of, based on identifying a device which is disconnected to the blockchain network or power-off, and not being able to perform an operation related to the blockchain, among the at least one device, identifying another device which is able to perform the operation related to the blockchain and is connected to the identified device, and requesting the another device to transmit a signal corresponding to a user input for controlling the identified device to the identified device.

The method may include the steps of, based on an encryption set value included in the first communication setting information set to be changed by a predetermined cycle, connection with the access point may be performed by using the second communication setting information before changing the encryption set value.

The blockchain network may store communication setting information of second communication circuitry different from the communication circuitry, log-in information of a service used by the user, and security information.

Meanwhile, in a method of controlling a system that shares communication setting information by using a blockchain network and includes an electronic device and at least one device according to an embodiment of the disclosure, the controlling method includes the steps of, based on the electronic device being connected to an access point by using first communication setting information, the electronic device recording the first communication setting information in the blockchain network, and the at least one device performing communicative connection to the access point by using the first communication setting information recorded in the blockchain network, and based on detecting an event for the electronic device to be connected to the access point by the second communication setting information, the electronic device recording the second communication setting information in the blockchain network while performing communicative connection with the access point by using the first communication setting information, and based on the recording of the second communication setting information in the blockchain network succeeding, the at least one device receiving the second communication setting information recorded in the blockchain network, and releasing communicative connection with the access point connected by using the first communication setting information, and the electronic device performing communicative connection with the access point by using the second communication setting information, and the at least one device performing communicative connection with the access point by using the second communication setting information.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include based on being connected to an access point by using first communication setting information, recording, by the electronic device, the first communication setting information in a blockchain network, and the blockchain network storing information on at least one device registered by the same user account as the electronic device, based on determining an event for connecting to the access point by second communication setting information has occurred, recording, by the electronic device, the second communication setting information in the blockchain network, and based on the recording of the second communication setting information in the blockchain network succeeding, performing, by the electronic device, connection with the access point by using the second communication setting information.

The operations may further include identifying security strength of a first security protocol included in the first communication setting information, based on the identifying the security strength, providing a user interface (UI) for changing a security protocol for connecting to the access point from the first security protocol to a second security protocol, the second security protocol having higher security strength than the first security protocol, and based on receiving a user input for changing the security protocol through the UI, determining that an event for connecting to the access point by the second communication setting information including the second security protocol has occurred.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for illustrating a blockchain network according to an embodiment of the disclosure;

FIG. 2 is a diagram illustrating an IoT system according to an embodiment of the disclosure;

FIG. 3 is a block diagram illustrating a configuration of an electronic device according to an embodiment of the disclosure;

FIG. 4 is a sequence diagram illustrating a controlling method of an IoT system for communicative connection according to an embodiment of the disclosure;

FIGS. 5A, 5B, 5C, and 5D are diagrams illustrating a controlling method of an IoT system for communicative connection according to various embodiments of the disclosure;

FIGS. 6, 7, and 8 are flow charts for illustrating embodiments of changing the setting of communicative connection in case a device in a state wherein communication is not connected or a state wherein the power is turned off exists according to various embodiments of the disclosure;

FIG. 9 is a flow chart for illustrating a controlling method of an electronic device for communicative connection by using a blockchain network according to an embodiment of the disclosure;

FIG. 10 is a diagram for illustrating a process of registering an L3 device to a blockchain network according to an embodiment of the disclosure;

FIG. 11 is a diagram for illustrating a process of recording updated information of an L3 device in a blockchain network according to an embodiment of the disclosure; and

FIG. 12 is a diagram for illustrating a process of releasing registration of an L3 device to a blockchain network according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Also, in describing the disclosure, in case it is determined that detailed explanation of related known functions or features may unnecessarily confuse the gist of the disclosure, the detailed explanation will be omitted.

In addition, the embodiments described below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Also, the terms used in the disclosure are used only to explain specific embodiments, and are not intended to limit the scope of the disclosure.

In addition, in the disclosure, expressions such as “have,” “may have,” “include,” and “may include” denote the existence of such characteristics (e.g.: elements such as numbers, functions, operations, and components), and do not exclude the existence of additional characteristics.

Further, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

Also, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to another element, and the case where the one element is indirectly coupled to another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

In addition, in the embodiments of the disclosure, ‘a module’ or ‘a unit’ may perform at least one function or operation, and may be implemented as hardware or software, or as a combination of hardware and software. Also, a plurality of ‘modules’ or ‘units’ may be integrated into at least one module and implemented as at least one processor, excluding ‘a module’ or ‘a unit’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth© chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Hereinafter, the embodiments according to the disclosure will be described in detail with reference to the accompanying drawings, such that those having ordinary skill in the art to which the disclosure belongs can easily carry out the disclosure.

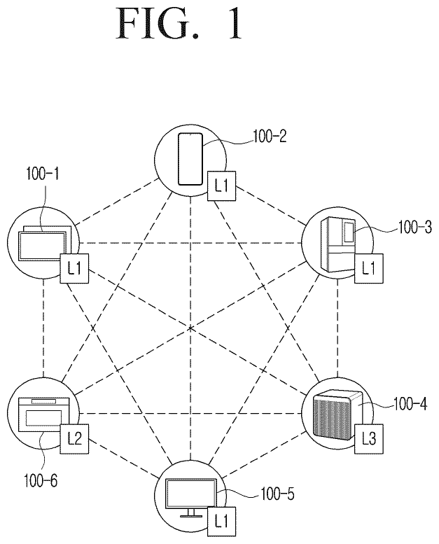

FIG. 1 is a diagram for illustrating a blockchain network according to an embodiment of the disclosure.

Referring to FIG. 1, a plurality of devices 100-1 to 100-6 may constitute a blockchain network.

Here, “a blockchain network” is a distributed network based on a blockchain technology, and is a system wherein several participants, but not a centralized server, jointly manage and verify trading records or data.

In particular, the blockchain network is a distributed structure, and several nodes participating in the network, but not a centralized server, store and manage information (or data). The information is stored in ‘block’ units, and each block is connected to a previous block and can form ‘a chain.’ Also, as all trades or changes to the information are recorded in the block only when the several participants verify them and agree, data that was once recorded is difficult to be changed, and thus transparency can be improved.

Referring to FIG. 1, the plurality of devices 100-1 to 100-6 may constitute a blockchain network. The plurality of devices 100-1 to 100-6 may be implemented as a plurality of types of electronic devices included in an IoT system. For example, the plurality of devices 100 may include a TV 100-1, a smart cooker 100-2, a monitor 100-3, an air purifier 100-4, a refrigerator 100-5, and a smartphone 100-6, but this is merely an example, and different types of devices may be included.

The plurality of devices 100-1 to 100-6 may be managed by at least one user account (an individual account or a family account, etc.). Specifically, the plurality of devices 100-1 to 100-6 may be managed by an account server 10.

The plurality of devices 100-1 to 100-6 may be divided into devices of a plurality of levels according to the computing capacity of the devices. For example, the plurality of devices 100-1 to 100-6 may be divided into devices of Level 1 to Level 3 by the standard as in the following Table 1.

TABLE 1

| | | Whether an | | |
|---|---|---|---|---|
| | Whether | operation related | | |
| | there is a | to the blockchain | Computing | |
| Level | display | can be performed | Capacity | Device |
| Level 1 | Yes | Possible | High | a smartphone, a |
| | | | | smart TV, a |
| | | | | family hub, a |
| | | | | laptop PC |
| Level 2 | Yes | Possible | Low | a speaker or an |
| | | | | acoustic device |
| Level 3 | No | Impossible | High/Low | an air purifier, |
| | | | | a washing |
| | | | | machine, a sensor |
| | | | | product, etc. |

For example, among the plurality of devices 100 illustrated in FIG. 1, the TV 100-1, the monitor 100-3, the refrigerator 100-5, and the smartphone 100-6 may be devices of Level 1 (referred to as “L1 devices” hereinafter), and the smart cooker 100-2 may be a device of Level 2 (referred to as “an L2 device” hereinafter), and the air purifier 100-4 may be a device of Level 3 (referred to as “an L3 device” hereinafter).

The plurality of devices 100-1 to 100-6 may record (or store) information on the devices in the blockchain network. According to an embodiment, the information on the devices may include communication setting information and state information of the devices. The communication setting information is information related to communicative connection with an access point, and may include an identifier of a device (a device identifier), service set identifier (SSID) information of the access point (AP), medium access control (MAC) address information of the access point, information on a communication setting method (e.g., a security protocol, etc.), information on a frequency band, information on a channel band size, timestamp information, password information, information on whether the access point is hidden, etc. The state information of the devices may include information on a state of communicative connection, information on a state of power on/off, etc.

According to an embodiment, the information on the devices may include communication setting information of a communication interface different from a Wi-Fi communication interface (e.g., a Bluetooth communication interface), log-in information of a service used by the user, and security information.

In particular, the plurality of devices 100-1 to 100-6 may change the setting of communication with the access point automatically by sharing the communication setting information through the blockchain network, and thus user convenience can be improved. Hereinafter, the disclosure will be described in more detail with reference to the drawings.

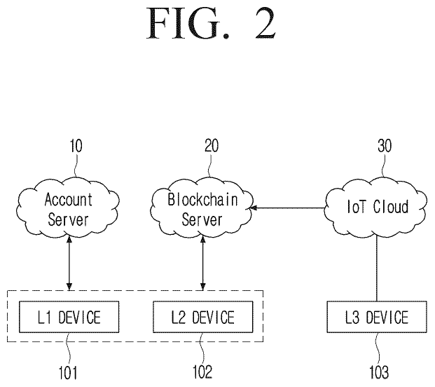

FIG. 2 is a diagram illustrating an IoT system according to an embodiment of the disclosure.

Referring to FIG. 2, the IoT system may include an account server 10, a blockchain server 20, an IoT cloud 30, and a plurality of devices 101, 102, 103. Meanwhile, the plurality of devices may include an L1 device 101, an L2 device 102, and an L3 device 103 according to the levels.

The account server 10 may perform functions such as managing a user account, registering the plurality of devices 101, 102, 103 by associating them with the user account, and managing or controlling the registered devices, etc. For example, the user may access the account server 10 through a user terminal, and generate a user account. The user account may be identified by an ID and a password set by the user. The account server 10 may register the plurality of devices 101, 102, 103 to the user account according to a designated procedure. For example, the account server 10 may connect identification information of a device (e.g., a serial number or a MAC address, etc.) to the user account, and register, manage, and control the device. Meanwhile, in the case of the L3 device 103, the L3 device 103 may not be immediately connected to the account server 10, but may be registered to the account server 10 through the IoT cloud 30 or the L1 device 101 and the L2 device 102.

The blockchain server 20 may manage the plurality of devices 101, 102, 103 as one blockchain group (or a blockchain membership, etc.). That is, the plurality of devices 101, 102, 103 of the same account may be managed as one group through the blockchain server 20. The blockchain server 20 may perform a role of transmitting and receiving messages between devices in the blockchain group. According to an embodiment, the L3 device 103 may be managed by the blockchain server 20 through the IoT cloud 30.

The IoT cloud 30 may be a server for storing, processing, analyzing, and managing data of the devices 101, 102, 103 in the IoT system. Specifically, the IoT cloud 30 may store data collected by the plurality of devices 101, 102, 103 in real time (e.g.: the temperature, the humidity, a location, etc.). Also, the IoT cloud 30 may process a large amount of data quickly, and analyze the data obtained from the plurality of devices 101, 102, 103 in real time, and respond immediately depending on needs. For example, if the IoT cloud 30 detects a change in the temperature in a home, it may execute operations such as turning on or turning off the heater, etc. immediately. The IoT cloud 30 may analyze the data collected from the plurality of devices 101, 102, 103 and extract useful information. In particular, the L3 device 103 may provide functions related to the IoT through the IoT cloud 30.

The plurality of devices 101, 102, 103 may be connected with one another through a network. The network may include a wide area network (WAN) such as the Internet, etc. and a local area network (LAN) formed around the access point, and a near field wireless network not via the access point. The near field wireless network may include Bluetooth (Institute of Electrical and Electronics Engineers (IEEE) 802.15.1), Zigbee (IEEE 802.15.4), Wi-Fi Direct, Near Field Communication (NFC), Z-Wave, etc., but is not limited thereto.

The access point may connect the plurality of devices 101, 102, 103 to the account server 10, the blockchain server 20, and the IoT cloud 30. The plurality of devices 101, 102, 103 may be connected to the various servers 10, 20, 30 through a wide area network (WAN).

The access point may communicate with the plurality of devices 101, 102, 103 by using wireless communication such as Wi-Fi (IEEE 802.11), Bluetooth (IEEE 802.15.1), Zigbee (IEEE 802.15.4), etc., and access the wide area network (WAN) by using wired communication, but is not limited thereto.

Meanwhile, the L1 device 101 and the L2 device 102 among the plurality of devices 101, 102, 103 may be connected to the account server 10 or the blockchain server 20 directly (or through the access point), but the L3 device 103 among the plurality of devices 101, 102, 103 may be connected to the account server 10 or the blockchain server 20 through the IoT cloud 30.

Also, the plurality of devices 101, 102, 103 may be connected by the blockchain network. In the blockchain network, connection setting information for Wi-Fi network connection using the access point may be recorded. Detailed explanation in this regard will be described later.

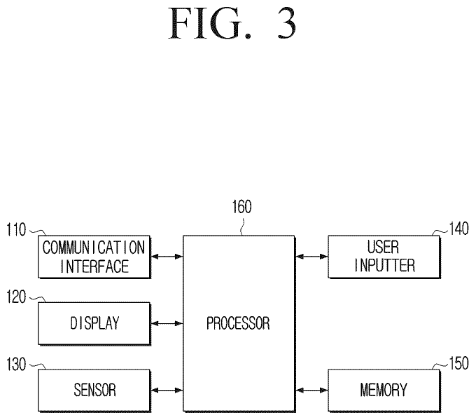

FIG. 3 is a block diagram illustrating a configuration of an electronic device according to an embodiment of the disclosure.

Referring to FIG. 3, the electronic device 100 includes a communication interface 110, a display 120, a sensor 130, a user inputter 140, memory 150, and a processor 160. However, this is merely an example, and it is obvious that some components can be removed or added according to the type of the electronic device 100. As an example, in case the electronic device 100 is an L1 device, components such as a camera, a microphone, etc. can be added, and in case the electronic device 100 is an L3 device, components such as the display 120, etc. can be removed.

The communication interface 110 includes at least one circuit, and may perform communication with various types of external devices or servers. The communication interface 110 may include at least one of a Bluetooth Low Energy (BLE) module, a Wi-Fi communication module, a cellular communication module, a 3rd generation (3G) mobile communication module, a 4th generation (4G) mobile communication module, a 4th generation (4G) long term evolution (LTE) communication module, or a 5th generation (5G) mobile communication module.

In particular, the communication interface 110 may transmit and receive various types of information from at least one external device or server. The communication interface 110 may perform communicative connection with the access point based on the communication setting information recorded in the blockchain network. Also, if an event wherein the communication setting information is changed is detected, the communication interface 110 may perform communicative connection with the access point based on the changed communication setting information.

The communication interface 110 may obtain information on the devices in the group recorded in the blockchain network. According to an embodiment, the communication interface 110 may receive communication setting information and state information of the devices in the group.

The display 120 may include various types of display panels such as a liquid crystal display (LCD) panel, an organic light-emitting diodes (OLED) panel, active-matrix organic light-emitting diodes (AM-OLED), liquid crystal on silicon (LcoS), quantum dot light-emitting diodes (QLED) and digital light processing (DLP), a plasma display panel (PDP), an inorganic LED panel, a micro LED panel, etc., but is not limited thereto. Meanwhile, the display 120 may constitute a touch screen together with a touch panel, or consist of a flexible panel.

In particular, the display 120 may provide a UI for changing the first security protocol to a second security protocol having higher security strength than the first security protocol. Also, the display 120 may provide a UI requesting communicative connection or power-on of a device in a state wherein communication is not connected or a state wherein the power is turned off. In addition, the display 120 may provide a UI for inquiring whether to change the setting of communicative connection after a standby time.

The sensor 130 may detect a state of the electronic device 100 (e.g.: a movement, a location), or an external environmental state (e.g.: a user state), and generate an electric signal or a data value corresponding to the detected state. The sensor 130 may include, for example, a gesture sensor and an acceleration sensor.

In particular, the sensor 130 may detect location information of devices around the electronic device 100.

The user inputter 140 may include a button type interface, a lever type interface, a switch type interface, a touch type interface, etc. The touch type interface may be implemented by a method of receiving an input by the user's touch on the screen of the display 120 of the electronic device 100. In particular, the user inputter 140 may receive various user inputs for controlling not only the electronic device 100, but also other devices.

The memory 150 may store an operating system (OS) for controlling the overall operations of the components of the electronic device 100, and instructions or data related to the components of the electronic device 100. In particular, the memory 150 may include a plurality of modules for performing communicative connection by using the blockchain network. In particular, when a function for performing communicative connection by using the blockchain network is executed, the electronic device 100 may load data for the various modules for performing communicative connection by using the blockchain network to perform various types of operations stored in non-volatile memory on volatile memory. Loading means an operation of calling in data stored in the non-volatile memory to the volatile memory and storing the data, so that the processor 160 can access the data.

Meanwhile, the memory 150 may be implemented as non-volatile memory (ex: a hard disk, a solid state drive (SSD), flash memory), volatile memory (may include the memory in the processor 160), etc.

The processor 160 may control the electronic device 100 according to the at least one instruction stored in the memory 150. In particular, the processor 160 may include one or more processors. Specifically, the at least one processor may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor may control one or a random combination of other components of the electronic device, and perform operations regarding communication or data processing. The at least one processor may execute one or more programs or instructions stored in the memory. For example, the at least one processor may perform the method according to an embodiment of the disclosure by executing the one or more instructions stored in the memory.

In case the method according to an embodiment of the disclosure includes a plurality of operations, the plurality of operations may be performed by one processor, or performed by a plurality of processors. That is, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor may be implemented as a single core processor including one core, or may be implemented as one or more multicore processors including a plurality of cores (e.g., multicores of the same kind or multicores of different kinds). In case the at least one processor is implemented as multicore processors, each of the plurality of cores included in the multicore processors may include internal memory of the processor such as cache memory, on-chip memory, etc., and common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor 160 may mean a system on chip (SoC) wherein at least one processor and other electronic components are integrated, a single core processor, a multicore processor, or a core included in the single core processor or the multicore processor. Also, the core may be implemented as a CPU, a GPU, an APU, a MIC, a DSP, an NPU, a hardware accelerator, or a machine learning accelerator, etc., but the embodiments of the disclosure are not limited thereto.

In particular, when the electronic device 100 is connected with the access point by using the first communication setting information, the processor 160, by executing at least one instruction, records the first communication setting information in the blockchain network. The blockchain network stores communication setting information of at least one device registered by the same user account as the electronic device 100. If an event for connecting to the access point by the second communication setting information is detected, the processor 160 records the second communication setting information in the blockchain network while performing communicative connection with the access point by using the first communication setting information. If the recording of the second communication setting information in the blockchain network succeeds, the processor 160 performs communicative connection with the access point by using the second communication setting information.

According to an embodiment, if information on a first security protocol having low security strength is included in the first communication setting information, the processor 160 may provide a UI for changing the first security protocol to a second security protocol having higher security strength than the first security protocol. Also, if a user input for changing to the second security protocol is received through the UI, the processor 160 may detect an event for connecting to the access point by the second communication setting information including the second security protocol.

According to an embodiment, if the recording of the second communication setting information in the blockchain network succeeds, the processor 160 may obtain state information of the at least one device recorded in the blockchain network. Also, if it is identified that a device in a state wherein communication is not connected and a state wherein the power is turned off does not exist among the at least one device based on the state information of the at least one device, the processor 160 may perform communicative connection with the access point by using the second communication setting information.

According to an embodiment, if a device in a state wherein communication is not connected or a state wherein the power is turned off exists among the at least one device based on the state information of the at least one device, the processor 160 may provide a UI requesting communicative connection or power-on of the device in a state wherein communication is not connected or a state wherein the power is turned off. If the communicative connection or the power-on of the device in a state wherein communication is not connected or a state wherein the power is turned off is performed, the processor 160 may perform communicative connection with the access point by using the second communication setting information.

According to an embodiment, if a device in a state wherein communication is not connected or a state wherein the power is turned off exists among the at least one device based on the state information of the at least one device, the processor 160 may provide a UI for inquiring whether to change the setting of communicative connection after a standby time. Also, if a user input for changing the setting of communicative connection after the standby time is received through the UI, the processor 160 may identify the standby time based on use pattern information of the device in a state wherein communication is not connected or a state wherein the power is turned off recorded in the blockchain network. The processor 160 may perform communicative connection with the access point by using the second communication setting information after the standby time passes.

According to an embodiment, if a device in a state wherein communication is not connected or a state wherein the power is turned off exists among the at least one device based on the state information of the at least one device, the processor 160 may provide a UI for inquiring whether to change the setting of communicative connection after a standby time. Also, if a user input for changing the setting of communicative connection immediately without the standby time is received through the UI, according to an embodiment, the processor 160 may perform communicative connection with the access point by using the second communication setting information. The device in a state wherein communication is not connected or a state wherein the power is turned off may perform communicative connection with the access point by obtaining the second communication setting information recorded in the blockchain network through a communication interface different from the communication interface.

In case the device in a state wherein communication is not connected or a state wherein the power is turned off is a device that cannot perform an operation related to the blockchain, according to an embodiment, the processor 160 may, if a device in a state wherein communication is not connected or a state wherein the power is turned off exists among the at least one device based on the state information of the at least one device, identify a device of a high specification connected to the device in a state wherein communication is not connected or a state wherein the power is turned off. The processor 160 may transmit a signal requesting to provide a UI requesting communicative connection or power-on of the device in a state wherein communication is not connected or a state wherein the power is turned off to the identified device of a high specification.

According to an embodiment, in case an encryption set value included in the first communication setting information is changed by a predetermined cycle, the processor 160 may perform communicative connection with the access point by using the second communication setting information before changing the encryption set value.

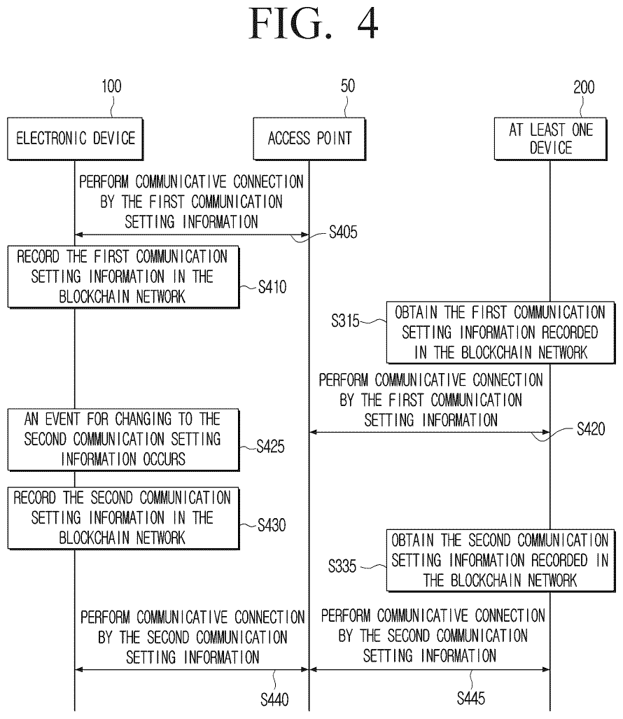

FIG. 4 is a sequence diagram illustrating a controlling method of an IoT system for communicative connection according to an embodiment of the disclosure.

Referring to FIG. 4, first, the electronic device 100 and the access point 50 may be communicatively connected by the first communication setting information in the operation S405. For example, the first communication setting information may include the information as illustrated in the following Table 2.

TABLE 2

| Data Item | Format | Example |
|---|---|---|
| Device Identifier | String | “f6b12601-996c-aad9-a0da-3895e72ec6a5” |
| SSID | String | “Test_AP” |
| BSSID | String | 11:22:33:44:55:66 |
| Security Code | Int | 1 |
| Security | String | WEP |
| Frequency Band | Int | 1 |
| Frequency | Int | 2412 |
| Frequency Width | Int | 20 |
| Timestamp | String | 1669114106000 |
| String | | |
| Passprase | String | 1234567890 |
| Hidden Status | Boolean | False |

According to an embodiment, the first communication setting information may include information on a security protocol by a wired equivalent privacy (WEP) method which is a first communication protocol having low security strength. The WEP security protocol is for reinforcing security of a wireless network, but may have weak security strength.

The electronic device 100 may record the first communication setting information in the blockchain network in the operation S410. That is, the electronic device 100 may record the first communication setting information for performing communicative connection with the access point 50 in the blockchain network. Meanwhile, the electronic device 100 may record the state information of the electronic device 100 other than the first communication setting information in the blockchain network.

The at least one device 200 may obtain the first communication setting information recorded in the blockchain network in the operation S315. The at least one device 200 may be a device that is managed through the same account as the electronic device 100 in the IoT system. In particular, the at least one device 200 may be managed as a group of the same blockchain network as the electronic device 100. Meanwhile, the at least one device 200 may obtain the first communication setting information recorded in the blockchain network through a Wi-Fi communication interface.

The at least one device 200 may perform communicative connection by using the first communication setting information in the operation S420. That is, the at least one device 200 may perform communicative connection with the access point by using the first security protocol having low security strength included in the first communication setting information.

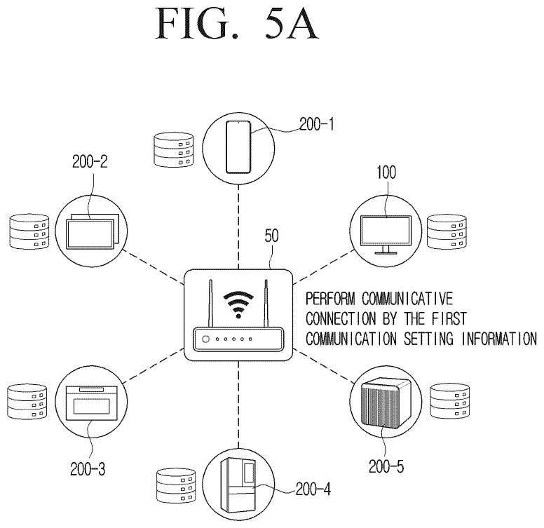

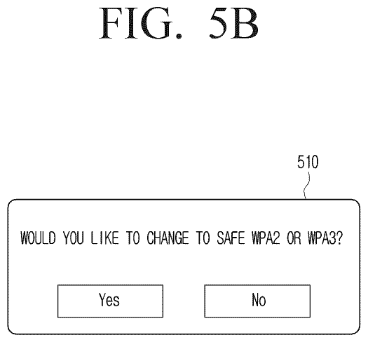

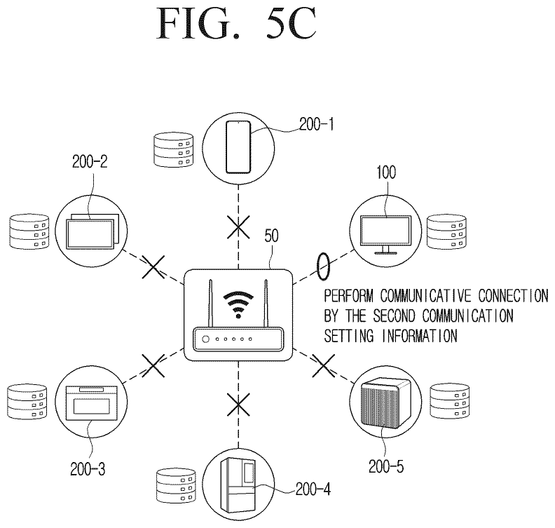

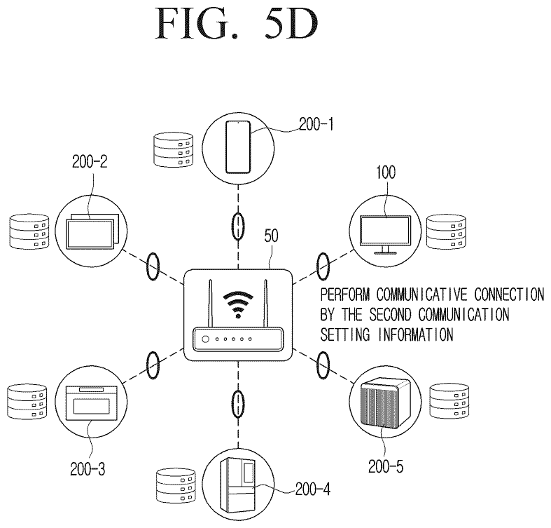

FIGS. 5A, 5B, 5C, and 5D are diagrams illustrating a controlling method of an IoT system for communicative connection according to various embodiments of the disclosure.

Referring to FIGS. 5A-5D, the electronic device 100 and the at least one device 200-1 to 200-5 may be connected with the access point 50 by the first communication setting information.

The electronic device 100 may detect generation of an event for changing to the second communication setting information in the operation S425. According to an embodiment, the electronic device 100 may identify that communicative connection with the access point 50 was performed through the first security protocol having low security strength included in the first communication setting information. That is, if information on the first security protocol having low security strength is included in the first communication setting information, the electronic device 100 may provide a UI for changing the first security protocol to the second security protocol (e.g., WPA, etc.) having higher security strength than the first security protocol. For example, as illustrated in FIG. 5B, the electronic device 100 may provide a UI 510 including a guide message such as “Would you like to change to safe WPA2 or WPA3?” Meanwhile, a UI 510 in a visual form as illustrated in FIG. 5B may be provided, but this is merely an example, and a guide message in an auditory form can obviously be provided. If a user input for changing to the second security protocol is received through the UI, the electronic device 100 may detect an event for connecting to the access point 50 by the second communication setting information including the second security protocol. For example, if a user input selecting the “Yes” UI element is received on the UI 510 illustrated in FIG. 5B, the electronic device 100 may detect an event for connecting to the access point 50 by the second communication setting information including the second security protocol.

According to an embodiment, in case the electronic device 100 is a device without a display, the electronic device 100 may identify a security protocol that performed communicative connection with the access point 50 by a predetermined cycle. If it is identified that communicative connection with the access point 50 was performed through the first security protocol having low security strength included in the first communication setting information, the electronic device 100 may detect an event for connecting to the access point 50 by the second communication setting information including the second security protocol.

The electronic device 100 may record the second communication setting information in the blockchain network in the operation S430. For example, the second communication setting information may include the information as illustrated in the following Table 3.

TABLE 3

| Data Item | Format | Example |
|---|---|---|
| Device Identifier | String | “f6b12601-996c-aad9-a0da-3895e72ec6a5” |
| SSID | String | “Test_AP” |
| BSSID | String | 11:22:33:44:55:66 |
| Security Code | Int | 1 |
| Security | String | WPA3 |
| Frequency Band | Int | 1 |
| Frequency | Int | 2412 |
| Frequency Width | Int | 20 |
| Timestamp String | String | 3869114106000 |
| Passprase | String | 1234567890 |
| Hidden Status | Boolean | False |

According to an embodiment, the second communication setting information may be communication setting information wherein the security protocol and the timestamp information in the first communication setting information have been changed, as illustrated in the Table 3. In particular, the second communication setting information may include information on a Wi-Fi Protected Access (WPA) security protocol having higher security strength than the first security protocol. The WPA security protocol may be a security protocol that was developed to reinforce security of a wireless network. In particular, the WPA security protocol is a security protocol that was made to solve the security problem of the WEP security protocol, and has developed to WPA2 and WPA3 afterwards.

The electronic device 100 may not perform communicative connection by the second communication setting information immediately, but wait until recording of the second communication setting information in the blockchain network succeeds. The feature that recording in the blockchain network succeeded may indicate that recording of information in the blockchain network was agreed by the plurality of devices participating in the blockchain network. Specifically, if communicative connection with the access point 50 is performed immediately through the second communication setting information, as illustrated in FIG. 5C, the electronic device 100 may immediately perform communicative connection with the access point 50 by the second communication setting information, but the communicative connection of the at least one device 200-1 to 200-5 may be released before obtaining the second communication setting information. Accordingly, in order that the at least one device 200-1 to 200-5 can obtain the second communication setting information, the electronic device 100 may not immediately perform communicative connection by the second communication setting information, but wait until recording of the second communication setting information in the blockchain network succeeds.

When the recording of the second communication setting information in the blockchain network succeeds, the at least one device 200 may obtain the second communication setting information recorded in the blockchain network in the operation S335. That is, the at least one device 200 may obtain the changed second communication setting information.

When the recording of the second communication setting information in the blockchain network succeeds, the electronic device 100 may perform communicative connection with the access point 50 by the second communication setting information in the operation S440. When the electronic device 100 is connected with the access point 50 by the second communication setting information, connection of the at least one device 200 with the access point 50 may be released.

After the connection with the access point 50 is released, the at least one device 200 may perform communicative connection with the access point 50 by the second communication setting information in the operation S445.

That is, as illustrated in FIG. 5D, the electronic device 100 and the at least one device 200-1 to 200-5 may be connected to the access point 50 by the second communication setting information. By this, communication setting of the plurality of devices existing in the IoT system can be automatically changed without a separate user input.

Meanwhile, while the second communication setting information is being recorded in the blockchain network, some devices in a state wherein communication is not connected or a state wherein the power is turned off may exist among the at least one device. In case a device in a state wherein communication is not connected or a state wherein the power is turned off exists, if the device in a state wherein communication is not connected and a state wherein the power is turned off is a smartphone, the second communication setting information recorded in the blockchain network may be identified through another communication interface (e.g., a cellular communication interface, etc.). However, in case the device in a state wherein communication is not connected or a state wherein the power is turned off does not include a cellular communication interface, it is difficult for the device in a state wherein communication is not connected or a state wherein the power is turned off to identify the second communication setting information recorded in the blockchain network.

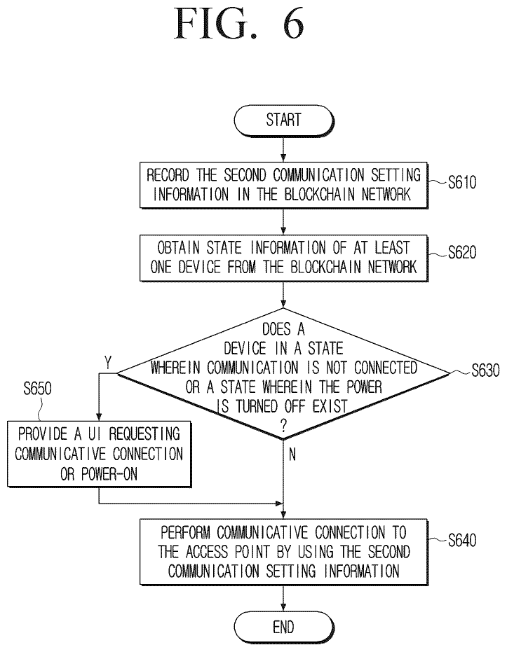

Hereinafter, a method for a device in a state wherein communication is not connected or a state wherein the power is turned off to identify the second communication setting information, in case a device in a state wherein communication is not connected or a state wherein the power is turned off exists while recording the second communication setting information in the blockchain network will be explained with reference to FIGS. 6 to 8.

FIG. 6 is a flow chart for illustrating an embodiment of changing the setting of communicative connection in case a device in a state wherein communication is not connected or a state wherein the power is turned off exists according to an embodiment of the disclosure.

Referring to FIG. 6, first, the electronic device 100 may record the second communication setting information in the blockchain network in the operation S610.

The electronic device 100 may obtain state information of the at least one device 200 from the blockchain network in the operation S620. The state information may include information on a state of communicative connection or a state of power on/off. For example, the state information may include the information as illustrated in the following Table 4. The state information may be recorded in the blockchain network whenever the state of the device is changed.

TABLE 4

| Data Item | Format | Explanation | Example |
|---|---|---|---|
| Power On/Off | int | Information on the current Power | “1” |
| | | On/Off of the device | |
| Connected/ | int | Information on the current | “1” |
| Disconnected | | Network Connected/Disconnected | |
| | | of the device | |

The electronic device 100 may identify whether a device in a state wherein communication is not connected or a state wherein the power is turned off exists based on the state information of the at least one device 200.

If it is identified that a device in a state wherein communication is not connected or a state wherein the power is turned off does not exist in the operation S630-N, the electronic device 100 may perform communicative connection with the access point 50 by using the second communication setting information in the operation S640. That is, if recording of the second communication setting information in the blockchain network succeeds, the electronic device 100 may immediately perform communicative connection with the access point 50 by using the second communication setting information.

If it is identified that a device in a state wherein communication is not connected or a state wherein the power is turned off exists in the operation S630-Y, the electronic device 100 may provide a UI requesting communicative connection or power-on in the operation S650. The UI may include a message requesting to perform communicative connection for the device in a state wherein communication is not connected or a message requesting to perform power-on for the device in a state wherein the power is turned off. Also, the UI may include information on the device in a state wherein communication is not connected or a state wherein the power is turned off (e.g., identification information, location information, etc. of the device). For example, the UI may include a message which is “Please perform communicative connection of the robot cleaner whose communicative connection has been cut off” or a message which is “Please turn on the power of the speaker that was turned off again.”

After the UI is provided, the electronic device 100 may perform communicative connection with the access point 50 by using the second communication setting information in the operation S640. According to an embodiment, the UI may include a UI element which is “Yes” (or a first UI element) or “No” (or a second UI element). If “Yes” is selected, the electronic device 100 may perform communicative connection with the access point 50 by using the second communication setting information after the device in a state wherein communication is not connected or a state wherein the power is turned off is communicatively connected or is turned on. If “No” is selected, the electronic device 100 may immediately perform communicative connection with the access point 50 by using the second communication setting information without a separate standby time.

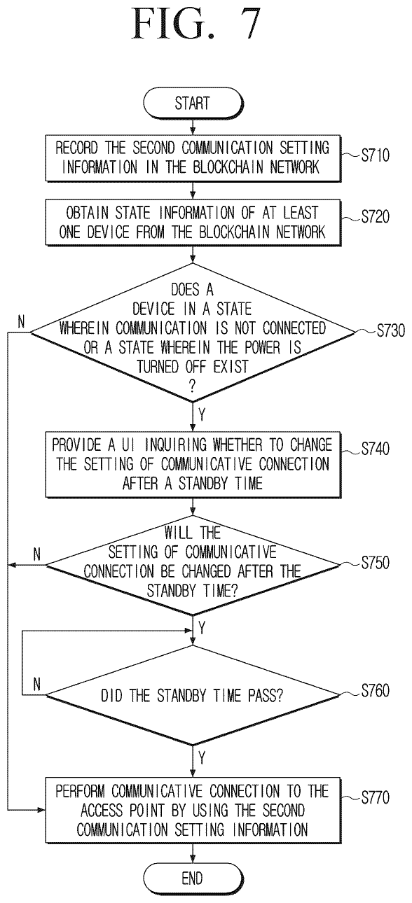

FIG. 7 is a flow chart for illustrating another embodiment of changing the setting of communicative connection in case a device in a state wherein communication is not connected or a state wherein the power is turned off exists according to an embodiment of the disclosure.

Referring to FIG. 7, as the operations of S710, S720, and S730 in FIG. 7 correspond to the operations of S610, S620, and S630 in FIG. 6, overlapping explanation will be omitted.

If it is identified that a device in a state wherein communication is not connected or a state wherein the power is turned off does not exist in the operation S730-N, the electronic device 100 may perform communicative connection with the access point 50 by using the second communication setting information in the operation S770. That is, if recording of the second communication setting information in the blockchain network succeeds, the electronic device 100 may immediately perform communicative connection with the access point 50 by using the second communication setting information.

If it is identified that a device in a state wherein communication is not connected or a state wherein the power is turned off exists in the operation S730-Y, the electronic device 100 may provide a UI inquiring whether to change the setting of communicative connection after a standby time in the operation S740. For example, the electronic device 100 may provide a UI which is “Would you like to change the communication setting after the robot cleaner that was turned off is turned on again?”

The electronic device 100 may identify whether to change the setting of communicative connection after the standby time based on a user input received through the UI in the operation S750.

If it is identified that the setting of communicative connection will not be changed after the standby time (i.e., if the “NO” UI element is identified on the UI) in the operation S750-N, the electronic device 100 may immediately perform communicative connection with the access point 50 by using the second communication setting information without a separate standby time. According to an embodiment, the at least one device 200 may perform communicative connection with the access point 50 by obtaining the second communication setting information recorded in the blockchain network through a communication interface different from the Wi-Fi communication interface (e.g., a cellular communication interface).

If it is identified that the setting of communicative connection will be changed after the standby time (i.e., if the “YES” UI element is identified on the UI) in the operation S750-Y, the electronic device 100 may identify whether the standby time passed in the operation S760. In particular, the electronic device 100 may identify the standby time based on the state information of the device recorded in the blockchain network. Specifically, the electronic device 100 may obtain the state information of the device in a state wherein communication is not connected or a state wherein the power is turned off recorded in the blockchain network. Then, the electronic device 100 may identify the use pattern (or the use history) of the device in a state wherein communication is not connected or a state wherein the power is turned off based on the state information of the device in a state wherein communication is not connected or a state wherein the power is turned off, and identify a standby time based on the identified use pattern. For example, if it is identified that the robot cleaner is turned on at 9 am every day based on the use pattern of the robot cleaner in a state wherein the power is turned off, the electronic device 100 may identify the time until 9 am the next day as the standby time.

If the standby time passed in the operation S760-Y, the electronic device 100 may perform communicative connection with the access point 50 by using the second communication setting information in the operation S770. That is, the electronic device 100 may perform communicative connection by waiting until the device in a state wherein communication is not connected or a state wherein the power is turned off is communicatively connected or is turned on again.

Meanwhile, in the aforementioned embodiment, it was explained that the electronic device 100 identifies the standby time based on the state information of a device in a state wherein communication is not connected or a state wherein the power is turned off. However, this is merely an example, and the electronic device 100 can obviously identify the standby time based on a user input.

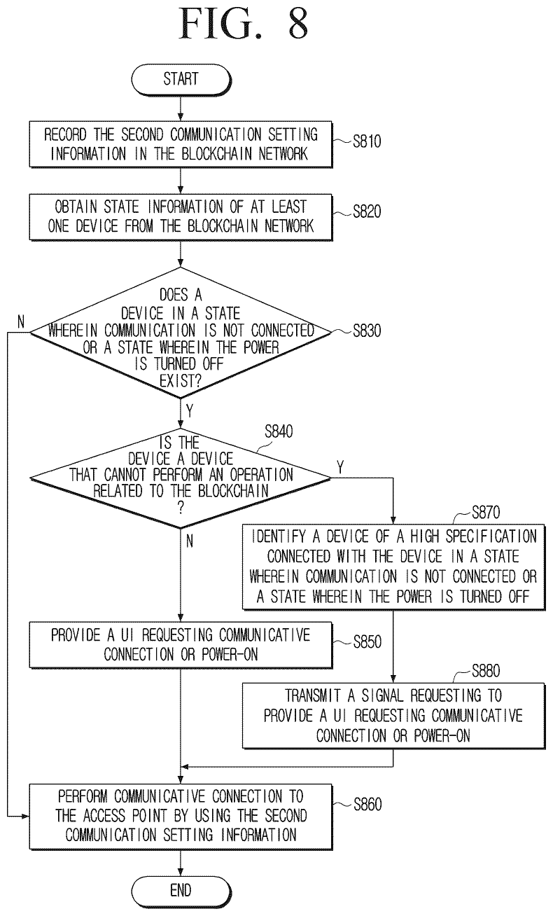

FIG. 8 is a flow chart for illustrating another embodiment of changing the setting of communicative connection in case a device in a state wherein communication is not connected or a state wherein the power is turned off exists according to an embodiment of the disclosure.

Referring to FIG. 8, as the operations of S810, S820, and S830 in FIG. 8 correspond to the operations of S610, S620, and to S630 in FIG. 6, overlapping explanation will be omitted.

If it is identified that a device in a state wherein communication is not connected or a state wherein the power is turned off does not exist in the operation S830-N, the electronic device 100 may perform communicative connection with the access point 50 by using the second communication setting information in the operation S860. That is, if recording of the second communication setting information in the blockchain network succeeds, the electronic device 100 may immediately perform communicative connection with the access point 50 by using the second communication setting information.

If it is identified that a device in a state wherein communication is not connected or a state wherein the power is turned off exists in the operation S830-Y, the electronic device 100 may identify whether the device in a state wherein communication is not connected or a state wherein the power is turned off is a device that cannot perform an operation related to the blockchain in the operation S840. That is, the electronic device 100 may identify whether the device in a state wherein communication is not connected or a state wherein the power is turned off is an L3 device. Information on whether the device in a state wherein communication is not connected or a state wherein the power is turned off is an L3 device may be stored in advance in the electronic device 100.

In case the device in a state wherein communication is not connected or a state wherein the power is turned off is not a device that cannot perform an operation related to the blockchain in the operation S840-N, the electronic device 100 may provide a UI requesting communicative connection or power-on in the operation S850. The UI may include a message requesting to perform communicative connection for the device in a state wherein communication is not connected or a message requesting to perform power-on for the device in a state wherein the power is turned off.

After the UI is provided, the electronic device 100 may perform communicative connection with the access point 50 by using the second communication setting information in the operation S860.

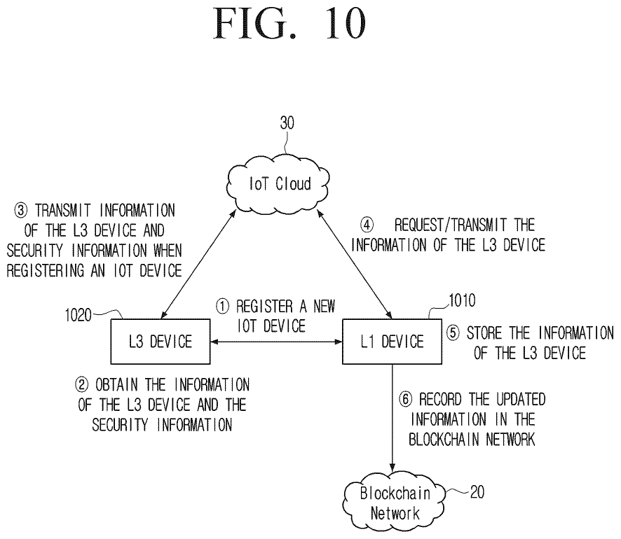

In case the device in a state wherein communication is not connected or a state wherein the power is turned off is a device that cannot perform an operation related to the blockchain in the operation S840-Y, the electronic device 100 may identify a device of a high specification connected to the device in a state wherein communication is not connected or a state wherein the power is turned off in the operation S870. The device of a high specification may be referred to as a parent device. The parent device may be a device that receives a user input for controlling the device in a state wherein communication is not connected or a state wherein the power is turned off, and transmits a control command corresponding to the user input to the device in a state wherein communication is not connected or a state wherein the power is turned off. Also, the parent device may provide a management function so that the device in a state wherein communication is not connected or a state wherein the power is turned off can be registered to an IoT device, or its registration can be released. Detailed explanation regarding the parent device will be described with reference to FIGS. 10 to 12 later.

The electronic device 100 may transmit a signal requesting to provide a UI requesting communicative connection or power-on to the parent device in the operation S880. The parent device may provide a UI requesting communicative connection or power-on.

After the UI is provided through the parent device, the electronic device 100 may perform communicative connection with the access point 50 by using the second communication setting information in the operation S860.

Meanwhile, in the aforementioned embodiment, it was explained that the electronic device 100 transmits a signal for requesting to provide a UI to the parent device, but this is merely an example, and the electronic device 100 can obviously transmit a signal for requesting to provide a UI to a device frequently used by the user (e.g., a smartphone) or a device that started to change the communication setting.

According to an embodiment, the devices in the IoT system may be connected with the access point by using the first communication setting information. In the first user terminal (in particular, a smartphone) among the devices included in the IoT system, the Wi-Fi communication interface may be in an inactivated (or off) state. If an event wherein the first communication setting information is changed to the second communication setting information is generated, the devices in the IoT system may perform communicative connection with the access point by using the second communication setting information by the method as explained above. If a user instruction for activating (or turning on) the Wi-Fi communication interface is input into the first user terminal, the first user terminal may obtain the second communication setting information recorded in the blockchain network through another communication interface (e.g., a cellular communication interface), and perform communicative connection with the access point by using the obtained second communication setting information.

According to an embodiment, a specific device among the devices in the IoT system may periodically change an encryption set value (e.g., an encryption password, etc.) among the communication setting information, and record the changed encryption set value in the blockchain network. In case the encryption set value included in the first communication setting information is changed by a predetermined cycle, the electronic device 100 may perform communicative connection with the access point 50 by using the second communication setting information before the encryption set value is changed. By this, the other devices in the IoT system may perform communicative connection with the access point 50 by using the communication setting information including the encryption set value before the change recorded in the blockchain network.

Meanwhile, in the blockchain network, communication setting information of a communication interface different from the communication interface, log-in information of a service used by the user, and security information may be stored.

According to an embodiment, in the blockchain network, setting information of a communication interface different from the Wi-Fi communication interface (e.g., a Bluetooth communication interface) may be recorded. For example, in case the first device is connected to an external device through a Bluetooth communication interface, the first device may record the communication setting information with the external device in the blockchain network. By this, the devices different from the first device in the IoT system may perform communicative connection with the external device through the Bluetooth communication interface by using the communication setting information with the external device recorded in the blockchain network.

According to an embodiment, in the blockchain network, log-in information of a service used by the user and security information may be stored. Specifically, each of the devices in the IoT system may obtain log-in information and security information required for using a specific service (e.g., F-Hub App Lock, F-Hub Backup and Restore). The devices that used the service may record the log-in information and the security information of the service in the blockchain network. By this, the other devices in the IoT system can perform a log-in operation for the service automatically based on the log-in information and the security information of the service recorded in the blockchain network. In particular, in case the user proceeds with software update or reset in any device among the devices in the IoT system, log-in information and security information of the previous service stored in the any device may be deleted. However, if Wi-Fi connection of the any device becomes possible afterwards, the any device can use the previous service identically as the past based on the log-in information and the security information of the previous service recorded in the blockchain network.

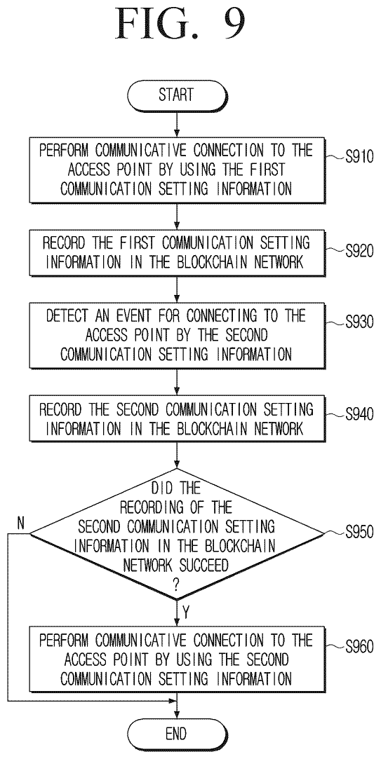

FIG. 9 is a flow chart for illustrating a controlling method of an electronic device for communicative connection by using a blockchain network according to an embodiment of the disclosure.

Referring to FIG. 9, the electronic device 100 may be connected with the access point 50 by using the first communication setting information in the operation S910. According to an embodiment, the first communication setting information includes information on the first security protocol having low security strength.

The electronic device 100 may record the first communication setting information in the blockchain network in the operation S920. The blockchain network may store communication setting information of at least one device registered by the same user account as the electronic device 100.

The electronic device 100 may detect an event for connecting to the access point 50 by the second communication setting information in the operation S930. According to an embodiment, in case the information on the first security protocol having low security strength is included in the first communication setting information, the electronic device 100 may detect an event for connecting to the access point 50 by the second communication setting information including information on the second security protocol having higher security strength than the first security protocol.

The electronic device 100 may record the second communication setting information in the blockchain network in the operation S940. The electronic device 100 may record the second communication setting information in the blockchain network while maintaining communicative connection with the access point 50 by using the first communication setting information.

The electronic device 100 may identify whether recording of the second communication setting information in the blockchain network succeeded in the operation S950.

If it is identified that the recording of the second communication setting information in the blockchain network succeeded in the operation S950-Y, the electronic device 100 may perform communicative connection with the access point 50 by using the second communication setting information in the operation S960. Specifically, the at least one device 200 may obtain the second communication setting information recorded in the blockchain network. Then, when the electronic device 100 is communicatively connected with the access point 50 by using the second communication setting information, the at least one device 200 may release communicative connection using the first communication setting information, and perform communicative connection with the access point 50 by using the second communication setting information.

Meanwhile, among devices in an IoT system, a device of a low specification (e.g., an L3 device) that cannot perform an operation related to the blockchain by itself may exist. For example, among devices in a home, a device that does not include a display, and cannot perform an operation related to the blockchain by itself due to computing capacity of a low specification and memory of a small capacity may exist.

An IoT system according to an embodiment of the disclosure may manage such that a device of a high specification (e.g., an L1 device or an L2 device) replaces a device of a low specification, and the device of a low specification can participate in the blockchain. The device of a high specification may be referred to as “a parent device,” and the device of a low specification may be referred to as “a child device.” Hereinafter, explanation will be described by assuming the device of a low specification as “an L3 device,” and assuming the device of a high specification as “an L1 device.”

Specifically, the L3 device may obtain security state information (referred to as “security information” hereinafter) to be recorded in the blockchain network. The security information may include information on whether secure booting will be performed, information on whether the software was updated recently, and information on whether automatic update of the software is turned on/off.

The L3 device may select a replacement device that will replace it in an operation of recording security information in the blockchain network through a policy for selecting a replacement device. According to an embodiment, in case a plurality of L1 devices that will replacively perform an operation of recording security information in the blockchain network exist in the IoT system, the L3 device may determine an L1 device which responds the fastest among the plurality of L1 devices as the replacement device. According to another embodiment, the L3 device may determine an L1 device which exists in the closest location or an L1 device which performed a role as a replacement device in the past among the plurality of L1 devices as the replacement device.

The L1 device determined as the replacement device may receive the security information from the L3 device, and record the security information in the blockchain network.

Hereinafter, an embodiment wherein an L3 device performs an operation related to the blockchain network by using an L1 device will be explained with reference to FIGS. 10 to 12.

FIG. 10 is a diagram for illustrating a process of registering an L3 device to a blockchain network according to an embodiment of the disclosure.

Referring to FIG. 10, first, when the L3 device 1020 is booted, the L3 device may obtain security information.

Then, the L1 device 1010 may register the L3 device 1020 as a new IoT device (\textcircled{1}). Specifically, the L3 device 1020 may receive a request of security information from the L1 device 1010 when proceeding with a registering process of an IoT device. The L3 device 1020 may select the L1 device 1010 as a device that will replacively participate in the blockchain network. That is, if the L1 device 1010 is selected as a replacement device, the L1 device 1010 may register the L3 device 1020 as a new IoT device.

After the device is registered, the L3 device 1020 may obtain information of the L3 device 1020 and security information (\textcircled{2}). The information of the L3 device 1020 may include identification information of the device, information on the trust level, signature information, model information, communication setting information, etc., and the security information may include information on whether secure booting will be performed, information on whether the software was updated recently, and information on whether automatic update of the software is turned on/off.

Then, the L3 device 1020 may transmit the information of the L3 device 1020 and the security information to the IoT cloud 30 when registering the IoT device (\textcircled{3}). The IoT cloud 30 may receive a request of the information of the L3 device 1020 from the L1 device 1010, and transmit the information of the L3 device 1020 in response to the request of the L1 device 1010 (\textcircled{4}).

The L1 device 1010 may store the information of the L3 device 1020 received from the IoT cloud 30 (\textcircled{5}), and record updated information (i.e., the information of the L3 device 1020) in the blockchain network 20 (\textcircled{6}).

Accordingly, the L1 device 1010 may register the L3 device 1020 as the IoT device in the IoT system through the aforementioned process, and register the information of the L3 device 1020 in the blockchain network 20.

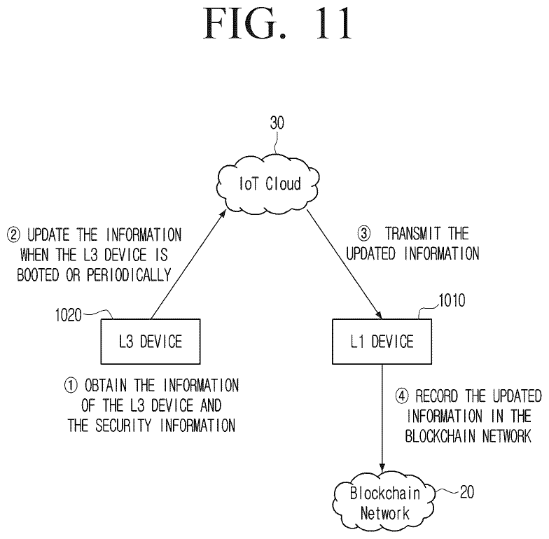

FIG. 11 is a diagram for illustrating a process of recording updated information of an L3 device in a blockchain network according to an embodiment of the disclosure.

Referring to FIG. 11, first, the L3 device 1020 may obtain information of the L3 device 1020 and security information (\textcircled{1}).

In particular, the L3 device 1020 may obtain the information of the L3 device 1020 and the security information when the L3 device 1020 is booted or periodically, and update the information of the L3 device 1020 and the security information in the IoT cloud 30 (\textcircled{2}).

The IoT cloud 30 may transmit the updated information of the L3 device 1020 to the L1 device 1010 (\textcircled{3}). The L1 device 1010 may be a parent device that was previously selected, but this is merely an example, and it may be an L1 device which responds the fastest or an L1 device which is located the closest.

The L1 device 1010 may record the updated information of the L3 device 1020 in the blockchain network (\textcircled{4}). In particular, in case information different from the previous information of the L3 device 1020 exists in the updated information of the L3 device 1020, the L1 device 1010 may record the information of the L3 device 1020 in the blockchain network 20.

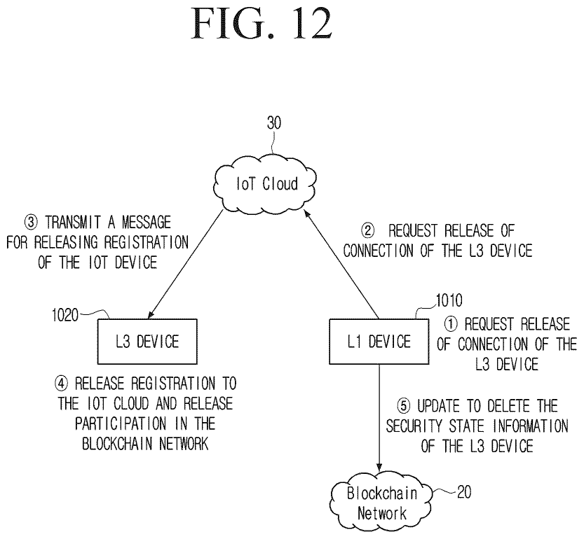

FIG. 12 is a diagram for illustrating a process of releasing registration of an L3 device to a blockchain network according to an embodiment of the disclosure.

Referring to FIG. 12, the L1 device 1010 may receive an input of a request for releasing connection of the L3 device 1020 (\textcircled{1}). That is, the L1 device 1010 may receive an input of a user instruction for releasing connection of the L3 device 1020 in the IoT system through the UI.

The L1 device 1010 may request release of connection of the L3 device 1020 to the IoT cloud 30 (\textcircled{2}).

The IoT cloud 30 may transmit a message for releasing registration of the IoT device to the L3 device 1020 (\textcircled{3}).

The L3 device 1020 may release registration to the IoT cloud 30, and release participation in the blockchain (\textcircled{4}). Also, the L1 device 1010 may update the blockchain network 20 so as to delete the security state information of the L3 device 1020 (including the information of the L3 device 1020) (\textcircled{5}).

According to an embodiment, in case a plurality of L1 devices and L3 devices 1020 exist, the L3 device 1020 may select one L1 device 1010 among the plurality of L1 devices as a replacement device through a policy for selecting a replacement device, and record the information on the L3 device 1020 in the blockchain network by using the selected L1 device. By this, the plurality of L1 devices and the user can identify the information on the L3 device 1020 through the blockchain network 20.

According to an embodiment, the L3 device 1020 may participate in the blockchain network 20 by transmitting the information on the L3 device 1020 to the L1 device 1010 through the IoT cloud 30 at the time of booting or periodically. Also, in case the L1 device which is the previous replacement device is in an inactivated state (a state wherein connection is not connected or a state wherein the power is turned off), the L3 device 1020 may participate in the blockchain network 20 by selecting a new L1 device as a replacement device.

According to an embodiment, in case the information on the L3 device 1020 is updated, the L3 device 1020 may not only select the previous L1 device as a replacement device, but also select a new L1 device as a replacement device and record the updated information on the L3 device 1020 in the blockchain network 20.

According to an embodiment, if a user instruction for releasing registration of the L3 device 1020 to the IoT cloud 30 is input, the information on the L3 device 1020 may be deleted from the blockchain network. By this, the plurality of L1 devices and the user can identify the information on the L3 device 1020 (i.e., release of registration to the IoT cloud 30) through the blockchain network 20.

Meanwhile, the method according to the various embodiments of the disclosure may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line (e.g.: download or upload) through an application store (e.g.: Play Store™) or directly between two user devices (e.g.: smartphones). In the case of on-line distribution, at least a portion of a computer program product (e.g.: a downloadable app) may be stored in a storage medium such as the server of the manufacturer, the server of the application store, and the memory of the relay server at least temporarily, or may be generated temporarily.

Also, the method according to the various embodiments of the disclosure may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: a TV).

Meanwhile, a storage medium readable by machines may be provided in the form of a non-transitory storage medium. The term ‘a non-transitory storage medium’ only means that a storage medium is a tangible device, and does not include signals (e.g.: electromagnetic waves), and the term does not distinguish a case wherein data is stored in the storage medium semi-permanently and a case wherein data is stored temporarily. For example, ‘a non-transitory storage medium’ may include a buffer wherein data is temporarily stored.

Also, in case an instruction is executed by a processor, the processor may perform a function corresponding to the instruction by itself, or by using other components under its control. An instruction may include a code that is generated or executed by a compiler or an interpreter.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication circuitry;
memory storing at least one instruction; and
at least one processor communicatively coupled to the communication circuitry and the memory,
wherein the at least one instruction, when executed by the at least one processor individually or collectively, causes the electronic device to:
based on being connected to an access point by using first communication setting information, record the first communication setting information in a blockchain network, and the blockchain network storing information on at least one device registered by the same user account as the electronic device;
based on determining an event for connecting to the access point by second communication setting information has occurred, record the second communication setting information in the blockchain network; and
based on the recording of the second communication setting information in the blockchain network succeeding, perform connection with the access point by using the second communication setting information.

2. The electronic device of claim 1, wherein the at least one instruction, when executed by the at least one processor individually or collectively, further causes the electronic device to:
identify security strength of a first security protocol included in the first communication setting information;
based on the identifying the security strength, provide a user interface (UI) for changing a security protocol for connecting to the access point from the first security protocol to a second security protocol, the second security protocol having higher security strength than the first security protocol; and
based on receiving a user input for changing the security protocol through the UI, determine that an event for connecting to the access point by the second communication setting information including the second security protocol has occurred.

3. The electronic device of claim 1, wherein the at least one instruction, when executed by the at least one processor individually or collectively, further causes the electronic device to:
based on the recording of the second communication setting information in the blockchain network succeeding, obtain the information on the at least one device recorded in the blockchain network; and
based on identifying each of at least one device being in a state of connected to the blockchain network and power-on, perform connection with the access point by using the second communication setting information.

4. The electronic device of claim 3, wherein the at least one instruction, when executed by the at least one processor individually or collectively, further causes the electronic device to:
based on identifying a device in a state of disconnected to the blockchain network or power-off among the at least one device, provide a UI requesting connection to the blockchain network or power-on of the identified device; and
based on the connection or the power-on of the identified device being performed, perform connection with the access point by using the second communication setting information.

5. The electronic device of claim 3, wherein the at least one instruction, when executed by the at least one processor individually or collectively, further causes the electronic device to:
based on identifying a device in a state of disconnected to the blockchain network or power-off among the at least one device, provide a UI for changing the first communication setting information after a standby time; and
based on receiving a user input, perform the connection with the access point by using the second communication setting information.

6. The electronic device of claim 5,
wherein the at least one instruction, when executed by the at least one processor individually or collectively, further causes the electronic device to:
based on a user input corresponding to the changing after the standby time, perform the connection with the access point by using the second communication information after elapsing the standby time; and
based on a user input corresponding to the changing without the standby time, perform the connection with the access point by using the second communication information immediately;
wherein the standby time comprises a time based on use pattern information of the identified device.

7. The electronic device of claim 3, wherein, the at least one instruction, when executed by the at least one processor individually or collectively, further causes the electronic device to:
based on identifying a device which is disconnected to the blockchain network or power-off, and not being able to perform an operation related to the blockchain, among the at least one device, identify another device which is able to perform the operation related to the blockchain and is connected to the identified device; and
request the another device to transmit a signal corresponding to a user input for controlling the identified device to the identified device.

8. The electronic device of claim 1, wherein the at least one instruction, when executed by the at least one processor individually or collectively, further causes the electronic device to: based on an encryption set value included in the first communication setting information being set to be changed by a predetermined cycle, perform connection with the access point by using the second communication setting information before changing the encryption set value.

9. The electronic device of claim 1, wherein the blockchain network stores communication setting information of second communication circuitry different from the communication circuitry, log-in information of a service used by a user, and security information.

10. A method performed by an electronic device, the method comprising:
based on being connected to an access point by using first communication setting information, recording, by the electronic device, the first communication setting information in a blockchain network, and the blockchain network storing information on at least one device registered by the same user account as the electronic device;
based on determining an event for connecting to the access point by second communication setting information has occurred, recording, by the electronic device, the second communication setting information in the blockchain network; and
based on the recording of the second communication setting information in the blockchain network succeeding, performing, by the electronic device, connection with the access point by using the second communication setting information.

11. The method of claim 10, wherein the method further comprises:
identifying security strength of a first security protocol included in the first communication setting information;
based on the identifying the security strength, providing a user interface (UI) for changing a security protocol for connecting to the access point from the first security protocol to a second security protocol, the second security protocol having higher security strength than the first security protocol; and
based on receiving a user input for changing the security protocol through the UI, determining that an event for connecting to the access point by the second communication setting information including the second security protocol has occurred.

12. The method of claim 10, wherein the performing of the connection comprises:
based on the recording of the second communication setting information in the blockchain network succeeding, obtaining the information on the at least one device recorded in the blockchain network; and
based on identifying each of at least one device being in a state of connected to the blockchain network and power-on, performing connection with the access point by using the second communication setting information.

13. The method of claim 12, wherein the performing of the connection comprises:
based on identifying a device in a state of disconnected to the blockchain network or power-off among the at least one device, providing a UI requesting connection to the blockchain network or power-on of the identified device; and
based on the connection or the power-on of the identified device being performed, performing connection with the access point by using the second communication setting information.

14. The method of claim 12, wherein the performing of the connection comprises:
based on identifying a device in a state of disconnected to the blockchain network or power-off among the at least one device, providing a UI for changing the first communication setting information after a standby time; and
based on receiving a user input, performing the connection with the access point by using the second communication setting information.

15. The method of claim 14, wherein the performing of the connection comprises:
based on a user input corresponding to the changing after the standby time, performing the connection with the access point by using the second communication information after elapsing the standby time; and
based on a user input corresponding to the changing without the standby time, performing the connection with the access point by using the second communication information immediately;
wherein the standby time comprises a time based on use pattern information of the identified device.

16. The method of claim 12, further comprising:
based on identifying a device which is disconnected to the blockchain network or power-off, and not being able to perform an operation related to the blockchain, among the at least one device, identifying another device which is able to perform the operation related to the blockchain and is connected to the identified device; and
requesting the another device to transmit a signal corresponding to a user input for controlling the identified device to the identified device.

17. The method of claim 10, further comprising:
based on an encryption set value included in the first communication setting information being set to be changed by a predetermined cycle, perform connection with the access point by using the second communication setting information before changing the encryption set value.

18. The method of claim 10, wherein the blockchain network stores communication setting information of second communication circuitry different from the communication circuitry, log-in information of a service used by a user, and security information.

19. One or more non-transitory computer-readable storage media storing one or more computer programs including computer-executable instructions that, when executed by one or more processors of an electronic device individually or collectively, cause the electronic device to perform operations, the operations comprising:
based on being connected to an access point by using first communication setting information, recording, by the electronic device, the first communication setting information in a blockchain network, and the blockchain network storing information on at least one device registered by the same user account as the electronic device;
based on determining an event for connecting to the access point by second communication setting information has occurred, recording, by the electronic device, the second communication setting information in the blockchain network; and
based on the recording of the second communication setting information in the blockchain network succeeding, performing, by the electronic device, connection with the access point by using the second communication setting information.

20. The one or more non-transitory computer-readable storage media of claim 19, the operations further comprising:
identifying security strength of a first security protocol included in the first communication setting information;
based on the identifying the security strength, providing a user interface (UI) for changing a security protocol for connecting to the access point from the first security protocol to a second security protocol, the second security protocol having higher security strength than the first security protocol; and
based on receiving a user input for changing the security protocol through the UI, determining that an event for connecting to the access point by the second communication setting information including the second security protocol has occurred.
